(19) United States
(12) Patent Application Publication
(10) Pub. No.: US 2026/0129004 A1
(43) Pub. Date: May 7, 2026

(54) Method and System for Transmitting Time-Critical Data within a Communication Network

(71) Applicant: Siemens Aktiengesellschaft, Muenchen (DE)

(72) Inventors: Harald ALBRECHT, Nürnberg (DE); Stephan HÖME, Schwabach (DE)

(21) Appl. No.: 19/116,231

(22) PCT Filed: Sep. 15, 2023
(86) PCT No.: PCT/EP2023/075378

§ 371 Date: Mar. 27, 2025

(30) Foreign Application Priority Data
Sep. 30, 2022 (EP) 22199091.4

(51) Int. Cl. H04L 47/80; H04L 47/70

(52) U.S. Cl. CPC H04L 47/805; H04L 47/826

(57) ABSTRACT

System and method for transmitting time-critical data within a communication network from or to control applications that are each provided via at least one flow control component that is chargeable on a flow control environment provided on a host, and executable there, wherein at least one virtual network adapter is assigned to each flow control component, where flow control components each send a reservation order to a reservation model assigned to the flow control environment to reserve resources for sending or transmitting data streams having time-critical data, where the reservation module sends a reservation request or reservation confirmation to each forwarding communication device or a higher-level control unit in accordance with assigned quality-of-service requirements, and where the reservation module authorises the queue control unit to grant the virtual network adapter access to send/receive queues of a physical network adapter in accordance with a priority assigned to the quality-of-service requirements.

### CROSS-REFERENCE TO RELATED APPLICATIONS

This is a U.S. national stage of application No. PCT/EP 2023/075378 filed 15 Sep. 2023. Priority is claimed on European Application No. 22199091.4 filed 30 Sep. 2022, the content of which is incorporated herein by reference in its entirety.

### BACKGROUND OF THE INVENTION

### 1. Field of the Invention

The present invention relates to a method for transmitting time-critical data within a communication network, in particular within a communication network of an industrial automation system, and a system, in particular a host, for implementing the method.

### 2. Description of the Related Art

Industrial automation systems normally comprise a large number of automation devices connected to one another via an industrial communication network and serve, in the context of a manufacturing or processing automation, for controlling or regulating systems, machines and/or devices. On the basis of time-critical framework conditions in industrial automation systems, for communication between automation devices, it is overwhelmingly real-time communication protocols such as PROFINET, PROFIBUS, real-time Ethernet or time-sensitive networking (TSN) that are used. In particular, control services and/or applications can be automated and distributed in a capacity-dependent manner across currently available servers or virtual machines of an industrial automation system.

WO 2022/042905 A1 relates to a method for providing time-critical services to each of which at least one server component is assigned, which are formed by way of a flow control component that can be loaded into a flow control environment and executed there. For each of the server components, a functional unit is made available for processing a communication protocol stack that is connected to a functional unit assigned to the flow control environment for processing a communication protocol stack. The services each comprise a directory service component for establishing services provided via the flow control environment. The directory service components are connected to one another via a separated communication interface. An aggregator component is connected to the separated communication interface via a further flow control component, which makes details available via the services provided by means of the server components outside the flow control environment.

EP 3 975 502 A1 describes a method for providing time-critical services via a flow control environment, where for each service at least one server component is provided, which is formed via a flow control component that can be loaded into the flow control environment and executed there. A configuration unit for at least one gateway component of a subnetwork comprising the flow control environment establishes globally valid access information assigned to addressing information of the server components that is valid within the subnetwork. Dependent upon an operating mode predetermined via the configuration unit, one or more gateway components connected in parallel and/or series are used. The at least one gateway component forwards service access requests in accordance with forwarding and/or filtering rules, which map the access information, and the operating mode to the server components.

Older European application with the application number 22177736.0 discloses a conventional method for providing control applications by means of flow control components for control applications the execution of which requires selected privileges. For this purpose, a specification of necessary safety-critical resources is established in each case. Based on the specifications, an additional flow control component is established that is intended for a provision of an access to the necessary safety-critical resources. Accordingly, an execution of the respective flow control component is started together with the additional flow control component. By way of a flow control environment, an interface for inter-process communication between the respective flow control component and the additional flow control component is established. Access to the respectively needed safety-critical resources is provided via inter-process communication between the respective flow control component and the additional flow control component.

US 2022/263770 A1 relates to a method for transmitting time-critical data within a communication network, where the time-critical data is transmitted from and/or to control applications that are each provided via a container. For the reservation of resources for sending or receiving data streams comprising time-critical data, the containers each transmit a reservation order to a reservation module that is assigned to a hypervisor.

Due to an increasingly flexible functional configuration of industrial automation devices, reloadable control applications are increasingly being used in automation devices. These control applications can be made available, for example, via container virtualization. In industrial automation systems, typically high demands exist with regard to deterministic communication, firstly, with defined quality-of-service properties and, secondly, in relation to a low-effort integration of industrial control applications.

Conventional standards for time-sensitive networks give little consideration to control applications implemented through container virtualization. In International Electrotechnical Commission (IEC) standard 60802, an “industrial profile” with technical components for time-sensitive networks is defined for industrial automation systems. However, control applications implemented via container virtualization are largely equated therein with virtual machines and software containers are therefore treated like physical terminals. This has the consequence for developers of control applications implemented via container virtualization that complex terminal software stacks must be integrated into their applications. This results again in high costs as well as commissioning and servicing effort.

### SUMMARY OF THE INVENTION

In view of the foregoing, it is therefore an object of the present invention to provide an apparatus and method for transmitting time-critical data within a communication network that enables a low-effort and reliable realization of control applications with deterministic communication properties on the basis of container virtualization.

These and other objects and advantages are achieved in accordance with the invention by a system and method in accordance with the invention for transmitting time-critical data within a communication network, where the time-critical data is transmitted from and/or to control applications that are each provided via at least one flow control component that can be loaded into a flow control environment installed on a host and that can be executed from there. Therein, at least one virtual network adapter is assigned to each flow control component.

Preferably, the flow control components operate within the flow control environment isolated from one another and collectively use an operating system kernel of the host. In particular, the flow control components can be or comprise software containers, WebAssembly or Java bytecode. In addition, the flow control components can also comprise container groups, such as pods. Fundamentally, alternative microvirtualization concepts, such as snaps, can also be used for the flow control components. Memory images for software containers can be called upon, for example, from a memory storage and provisioning system that can be accessed via a large number of users reading and/or writing.

The flow control environment can be, in particular, a container runtime environment and/or container engine via which a setting up, deletion and/or linking of virtual resources occurs. Therein, the virtual resources comprise software containers, virtual communication networks and connections assigned thereto. For example, the flow control environment can comprise a Docker engine or a snap core that operates on a server facility.

In principle, other (orchestrated) container runtime environments, such as Podman or Kubernetes, can also be used. As an alternative to a container runtime environment, for the flow control environment, a WebAssembly runtime environment or a Java Virtual Machine can also be used.

In accordance with the invention, transmit/receive queues of at least one physical network adapter of the host are dynamically assigned by a queue control unit to the virtual network adapters. The physical network adapter therein comprises, in particular, a PHY component and an MAC component. Preferably, the virtual network adapters are each assigned by the queue control unit within the flow control environment to the flow control components.

In order to reserve resources for sending and/or receiving data streams comprising time-critical data, the flow control components send, in each case, a reservation order to a reservation module assigned to the flow control environment. On the basis of quality-of-service requirements assigned to the flow control components, in each case, the reservation module sends a reservation request or reservation confirmation to the communication devices passing on the respective data stream or to a higher-level control unit of the communication network for reserving the resources.

The resources for transmitting the data streams comprise, in particular, usable transfer time windows, bandwidth, assured maximum latency, queue count, queue cache and/or address cache in switches or bridges as forwarding communication devices. A forwarding of the data streams within the communication network is controlled via frame preemption, in particular in accordance with Institute of Electrical and Electronics Engineers (IEEE) standard 802.1Q, via time-aware shapers, in particular in accordance with IEEE standard 802.1Q, via credit-based shapers, in particular in accordance with IEEE standard 802.1Q, via burst limiting shapers, via peristaltic shapers and/or via priority-based shapers. The standards cited are specified for the implementation of time-sensitive networks (TSN).

The reservation request or confirmation can be, in particular, a talker advertise, talker announce, listener ready or listener join message. Additionally, the quality-of-service (QoS) requirements are advantageously each assigned to the flow control components based on a classification of their respective real-time requirement. The classification of the flow control components takes place, for example, in accordance with a classification guideline.

In accordance with the invention, the reservation module causes the queue control unit to grant to the virtual network adapter of the respective flow control component access to the transmit/receive queues of the physical network adapter, in accordance with a priority assigned to the quality-of-service requirements. Preferably, the resources for transmitting the data streams are reserved in the respective forwarding communication devices, given sufficient availability. In particular, only following a successful reservation does the reservation module cause the queue control unit to grant the virtual network adapter of the respective flow control component access to the transmit/receive queues of the physical network adapter.

With the present invention, the integration and maintenance of software stacks, in particular for time-sensitive networks in container-based control applications, is dispensed with. Specifically, via the reservation module and the queue control unit, easily usable application interfaces are provided within the flow control environment for container-based control applications. Overall, this enables a simple use of hosts with correspondingly virtualized control applications in time-sensitive networks and a transparent support for different hardware configurations dependent upon the output requirements placed on the respective time-sensitive network.

In accordance with a preferred embodiment of the present invention, the reservation module sends the reservation requests or confirmations according, in each case, to a reservation protocol selected for the respective flow control component to the forwarding communication devices or the higher-level control unit of the communication network. Therein, the reservation module can select the reservation protocol, for example, based on information provided by a forwarding communication device to which the host is connected, in particular in accordance with IEEE standard 802.1Q, and/or based on information provided by the higher-level control unit of the communication network. The reservation module assumes these functions for the respective control application. As a result, it is no longer necessary for the control applications to take account of specifics regarding the selection of a suitable reservation protocol.

In accordance with a further preferred embodiment of the present invention, the queue control unit, when granting access to the transmit/receive queues of the physical network adapter, activates host-internal hardware and/or software interfaces between the respective virtual network adapter and at least one selected transmit/receive queue. In this way, a rapid, reliable and appropriate allocation of the transmit/receive queue is ensured. Accordingly, when granting access to the transmit/receive queues, the queue control unit can reserve available transmit/receive queues and hardware and/or software interfaces for the flow control components for transmitting the data streams.

In particular, the queue control unit configures the physical network adapter so that reserved transmit/receive queues are available to the assigned virtual network adapters of the flow control components with the priority assigned to each respective flow control component. Thereby, a consistent allocation of host-internal resources for transmitting and/or receiving prioritized data streams is achieved via the flow control components.

Advantageously, the queue control unit notifies the reservation module, following a successful configuration of the physical network adapter, in each case, of the virtual network adapters and transmit/receive queues to be used for the transmission of the data streams. The reservation module sends this information as confirmation of the reservation order to the respective flow control component. Based on the information included by the confirmation of its respective reservation order, each flow control component can set up a data stream access point, in particular as a socket, and can send and/or receive the data streams in a targeted manner via the virtual network adapters and transmit/receive queues that are to be used. This enables a simple and safe establishment of data streams for the flow control components. Preferably, the virtual network adapters are assigned as needed by the queue control unit to the flow control components for transmitting and/or receiving the data streams and are each connected to a functional unit for implementing a network protocol stack of the respective flow control components. Thus, host-internal resources can be used particularly efficiently.

Communication devices and/or control applications sending data streams preferably each send, for notification of subscribable data streams, first datagrams comprising a data stream identifier and specify in the first datagrams quality-of-service parameters characterizing quality-of-service requirements for the respective data stream. Contrasted with this, for reserving resources to be provided by forwarding communication devices for a transmission of the data streams, communication devices and/or control applications receiving data streams each send second datagrams and specify in these the respective data stream identifier. With the first and second datagrams, the forwarding communication devices each reserve resources, given sufficient availability, for transmitting the data streams according to the specified quality-of-service parameters. The availability is therein checked by the higher-level control unit of the communication network and/or the forwarding communication devices. This enables a high degree of conformity with existing standards for time-sensitive networks.

The objects and advantages are achieved in accordance with the invention by a system for performing the method in accordance with disclosed embodiment, which comprises a flow control environment installed on a host and at least one flow control component for providing a control application. The flow control component can be loaded into the flow control environment and executed there. Additionally, the system comprises a queue control unit and a reservation module assigned to the flow control environment. The system is configured so that time-critical data is transmitted from and/or to the control application and so that at least one virtual network adapter is assigned to the flow control component.

The queue control unit of the system in accordance with the invention is configured to assign transmit/receive queues of at least one physical network adapter of the host dynamically to virtual network adapters. Furthermore, in order to reserve resources for sending and/or receiving data streams comprising time-critical data, the flow control component is configured, in each case, to send a reservation order to the reservation module. By contrast therewith, the reservation module is configured, on the basis of quality-of-service requirements assigned to flow control components, in each case, to send a reservation request or confirmation to communication devices forwarding the respective data stream or to a higher-level control unit of a communication network for reserving the resources. Additionally, the reservation module is configured to cause the queue control unit to grant the virtual network adapter of the respective flow control component access to the transmit/receive queues of the physical network adapter, in accordance with a priority assigned to the quality-of-service requirements.

In accordance with an advantageous embodiment of the system in accordance with the invention, this comprises a communication network with a plurality of communication devices. In addition, the flow control components are configured to operate within the flow control environment isolated from one another and collectively to use an operating system kernel of the host. Preferably, the queue control unit is configured to assign the virtual network adapters to the flow control components, in each case, within the flow control environment. Finally, the communication network is configured to reserve the resources for transmitting the data streams in the respective forwarding communication devices, given sufficient availability. Overall, this enables a consistent allocation of resources for transmitting and/or receiving data streams via flow control components both within the host and also throughout the communication network.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention will now be described in greater detail making reference to an exemplary embodiment illustrated in the drawing, in which:

FIG. 1 is a flowchart of a system for transmitting time-critical data within a communication network from and/or to control applications that are provided via flow control components in accordance with the invention; and

FIG. 2 is a flowchart of the method in accordance with the invention.

### DETAILED DESCRIPTION OF THE EXEMPLARY EMBODIMENTS

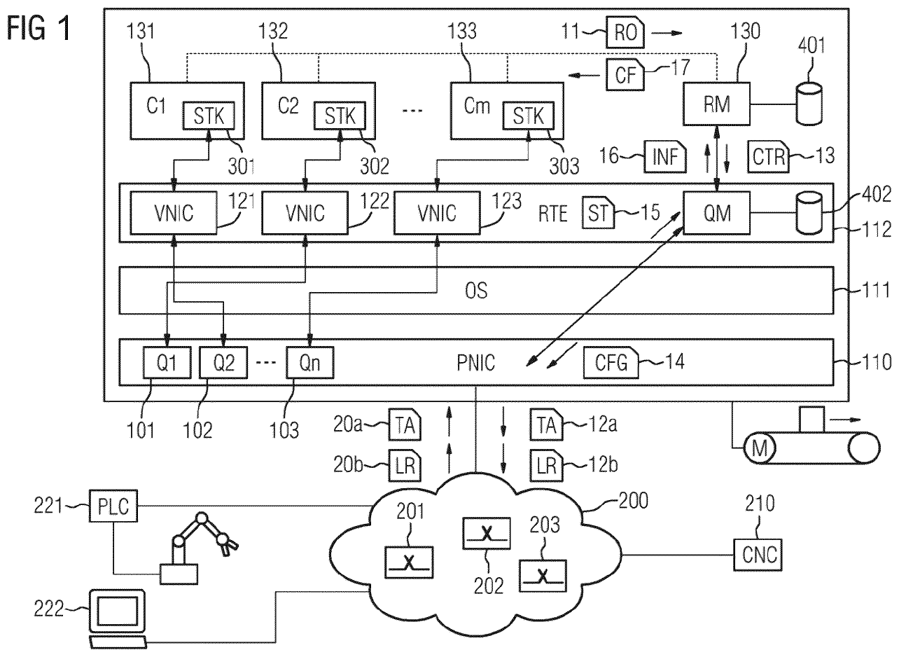

The system illustrated in FIG. 1 comprises a host 100 for providing control applications of an industrial automation system via flow control components 131, 132, 133, which in the present exemplary embodiment are implemented by software containers. The control applications of the industrial automation system are examples of time-critical services and can also comprise monitoring functions. Furthermore, the system comprises a communication network 200 having a plurality of data forwarding communication devices 201, 202, 203, in particular switches, a plurality of terminals 221-222, such as memory-programmable control systems or operating and observation stations, and a higher-level control unit 210 such as a central network controller.

With the control applications, the host 100 can implement, for example, functions of control devices of an industrial automation system such as memory-programmable control systems, or field devices such as sensors or actuators. In this way, the host 100 can be used, in particular, for an exchange of control and measuring variables with machines or apparatuses controlled by the host 100. Therein, the host 100 can establish suitable control variables for the machines or apparatuses from acquired measurement variables.

Alternatively or additionally, the host 100 can implement functions of an operating and observing station via the control applications and can thus be used for visualizing process data and/or measurement and control variables that are processed and/or acquired by automation devices. In particular, the host 100 can be used for displaying values of a control loop and for changing control parameters or control programs.

The flow control components 131, 132, 133 assigned to the control applications can be loaded into a flow control environment 112 and executed there. The flow control environment 112 is provided via the host 100 and is installed there as an application on an operating system 111 of the host 100. In the present exemplary embodiment, the flow control components 131, 132, 133 are and/or comprise software containers, which each operate isolated from other software containers, container groups and/or pods within the flow control environment 112. Therein, collectively with other software containers operating on the host 100, the software containers each use a kernel of the operating system 111 of the host 100. The flow control environment 112 can be, in particular, a container engine via which a setting up, deletion and/or linking of virtual resources occurs. Therein, the virtual resources can comprise software containers, virtual communication networks and connections assigned thereto.

An isolation of the flow control components and/or an isolation of selected operating system means from one another can be realized, in particular, via control groups and namespacing. With control groups, process groups can be defined to restrict available resources for selected groups. Via namespaces, individual processes or control groups can be isolated and/or hidden from other processes or control groups. Memory images for software containers can be called upon, for example, from a memory storage and provisioning system that is accessible to a large number of users reading and/or writing.

For the transmission of time-critical data within the communication network 200, it being transmitted from and/or to the control applications that are provided via the flow control components 131, 132, 133, a virtual network adapter 121, 122, 123 is assigned to each of the flow control components 131, 132, 133 via a queue control unit 120 within the flow control environment 112. With the queue control unit 120, in turn, dynamic transmit/receive queues 101, 102, 103 of a physical network adapter 110 of the host 100 are assigned to the virtual network adapters 121, 122, 123. The virtual network adapters 121, 122, 123 can be configured, for example, as virtual functions (VFs) in the context of single root I/O virtualization (SR-IOV). Alternatively thereto, the virtual network adapters 121, 122, 123 can also be realized as PCIe scalable functions or subfunctions (SFs) depending upon the network adapter hardware and the selected virtualization solution.

In order to reserve resources for transmitting and/or receiving data streams (streams) comprising time-critical data, the flow control components 131, 132, 133 each send a reservation order 11 to a reservation module 130 assigned to the flow control environment 112. The resources for transmitting the data streams comprise, in particular, usable transfer time windows, bandwidth, assured maximum latency, queue count, queue cache and/or address cache in the switches 201, 202, 203 of the communication network 200. Therein, a forwarding of the data streams within the communication network 200 can be controlled, in particular, by means of frame preemption in accordance with IEEE standard 802.1Q, time-aware shapers in accordance with IEEE standard 802.1Q, credit-based shapers in accordance with IEEE standard 802.1Q, burst limiting shapers, peristaltic shapers and/or priority-based shapers.

Based on the quality-of-service requirements assigned to the flow control components 131, 132, 133, in each case, the reservation module 130 sends a reservation request 12a or reservation confirmation 12b to the communication devices 201, 202, 203 forwarding the respective data stream or the higher-level control unit 210 of the communication network 200 for reserving the resources. In the present exemplary embodiment, the quality-of-service (QoS) requirements are assigned to the flow control components 131-133 based on, in each case, a classification of their respective real-time requirements. This classification of the flow control components 131, 132, 133 occurs via the registration module 130 based on a classification guideline that is deposited in a database 401 assigned to the registration module 130.

The reservation module 130 sends the reservation requests 12a or reservation confirmations 12b to the forwarding communication devices 201-203 or the higher-level control unit 210 of the communication network, each in accordance with a reservation protocol selected for the respective flow control component 131, 132, 133. Preferably, the reservation module 130 selects the reservation protocol on the basis of information provided via a forwarding communication device 201-203 to which the host 100 is connected, in accordance with IEEE standard 802.10 and/or based on information provided via the higher-level control unit 210 of the communication network 200.

In the present exemplary embodiment, talkers as communication devices and/or control applications sending data streams send talker advertise messages 12a, 20a, each comprising a data stream identifier for notification of subscribable data streams, and in these messages specify quality-of-service parameters characterizing quality-of-service requirements for the respective data stream. Contrasted with this, listeners as communication devices receiving data streams and/or control applications each send listener ready messages 12b, 20b for reserving resources to be provided by way of the forwarding communication devices 201, 202, 203 for transmitting the data streams, and specify the respective data stream identifier in these messages.

The forwarding communication devices 201, 202, 203 each reserve, on the talker advertise messages 12a, 20a and on the listener ready messages 12b, 20b, given sufficient availability, resources for transmitting the data streams in accordance with the specified quality-of-service parameters. The availability of the required resources along paths coming into consideration for the transmission of the data streams through the higher-level control unit 210 of the communication network and/or the forwarding communication devices is checked. This is dependent upon whether a centralized or decentralized stream reservation model is used. In each case, the communication network 200 is configured to reserve the resources for transmitting the data streams, given sufficient availability, in the respective forwarding communication devices 201, 202, 203.

The reservation module 130 causes the queue control unit 120 to grant the virtual network adapter 121, 122, 123 of the respective flow control component 131-133 access, via a control command 13, to the transmit/receive queues 101, 102, 103 of the physical network adapter 110, in accordance with a priority assigned to the quality-of-service requirements. Advantageously, only upon successful reservation of the resources in the communication network 200 does the reservation module 130 cause the queue control unit 120 to grant the virtual network adapter 121, 122, 123 of the respective flow control component 131, 132, 133 access to the transmit/receive queues 101, 102, 103 of the physical network adapter 110.

Upon grant of the access to the transmit/receive queues 101, 102, 103 of the physical network adapter 110, the queue control unit 120 activates host-internal hardware and/or software interfaces 501, 502, 503 (not shown) between the respective virtual network adapter 121, 122, 123 and at least one selected transmit/receive queue 101, 102, 103. In order to select a transmit/receive queue 101, 102, 103 and to activate the hardware and/or software interfaces 501, 502, 503 (not shown), the queue control unit acquires virtual network adapters 121, 122, 123 already used for a transmission of data streams and activated hardware and/or software interfaces 501, 502, 503 (not shown). The queue control unit 120 records this in an associated database 402. In this database 402, in particular, descriptions of available hardware functions of the physical network adapter 110 and information regarding an allocation of the transmit/receive queues 101, 102, 103 to groups and regarding quantity frameworks of possible virtual interfaces per physical network adapter can also be stored.

The queue control unit, when granting access to the transmit/receive queues 101, 102, 103, reserves available transmit/receive queues 101, 102, 103 and hardware and/or software interfaces 501, 502, 503 (not shown) for the flow control components 131, 132, 133 for transmitting the data streams. Additionally, the queue control unit 120 configures the physical network adapter 110 via a configuration command 14 so that reserved transmit/receive queues are available to the assigned virtual network adapters of the flow control components with the priority assigned to each respective flow control component. Following completed configuration of the physical network adapter 110, it sends a status information item 15 back for confirmation to the queue control unit 120.

The queue control unit 120 notifies the reservation module 130, following a completed configuration of the physical network adapter, in each case, via a response message 15, of virtual network adapters 121, 122, 123 and transmit/receive queues 101, 102, 103 that are to be used for transmitting the data streams. The reservation module sends this information 17 to the respective flow control component 131, 132, 133 as confirmation of the reservation order 11. Based on the information included by the confirmation of its respective reservation order 11, each flow control component 131, 132, 133 sets up a data stream access point, in particular as a socket, and sends and/or receives the data streams in a targeted manner via the respective virtual network adapters 121, 122, 123 and transmit/receive queues 101, 102, 103 that are to be used. Preferably, the virtual network adapters 121, 122, 123 are assigned as needed by the queue control unit 120 to the flow control components 131, 132, 133 for transmitting and/or receiving the data streams and are each connected to a functional unit 301, 302, 303 for implementing a network protocol stack of the respective flow control components 131, 132, 133.

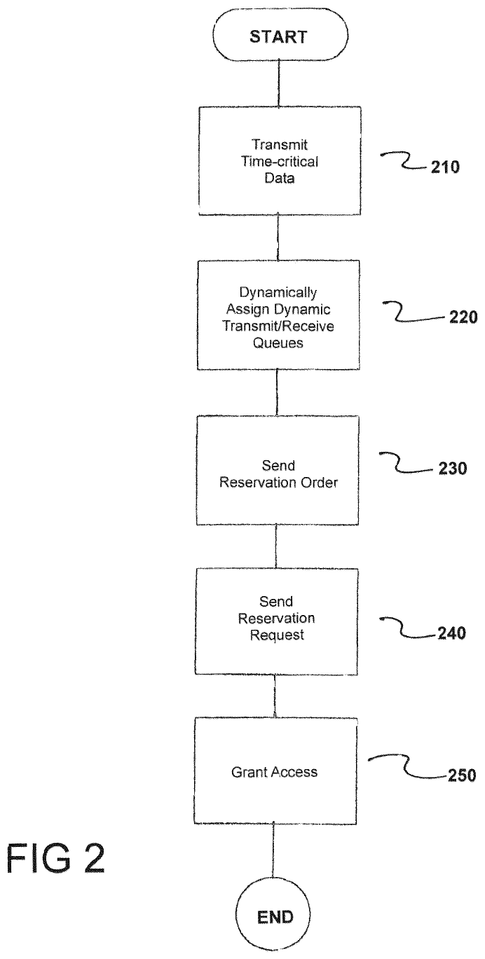

FIG. 2 is a flowchart of the method for transmitting time-critical data within a communication network.

The method comprises transmitting the time-critical data at least one of (i) from control applications and (ii) to control applications which are each provided via at least one flow control component 131, 123, 133 which is loadable into a flow control environment 112 installed on a host 100 and executable therein, as indicated in step 210. In accordance with the inventive method, a virtual network adapter 121, 122, 123 is assigned to each of the flow control components 131, 132, 133.

Next, the queue control unit 120 dynamically assigns dynamic transmit/receive queues 101, 102, 103 of at least one physical network adapter 110 of the host 100 to the virtual network adapters 121, 122, 123, as indicated in step 220.

Next, each flow control component 131, 132, 133 sends a reservation order 11 to a reservation module 130 assigned to the flow control environment 112 to reserve resources for sending and/or receiving time-critical data streams comprising time-critical data, as indicated in step 230.

Next, the reservation module 130 sends a reservation request 12a or reservation confirmation 12b to each communication device 201, 202, 203 forwarding the respective data stream or to a higher-level control unit 210 of the communication network 200 for reserving the resources based on the quality-of-service requirements assigned to the flow control components 131, 132, 133, as indicated in step 240.

Next, the queue control unit grants, via the reservation module 130, access by a respective virtual network adapter 121, 122, 123 of a respective flow control component 131, 132, 133 to the dynamic transmit/receive queues 101, 102, 103 of the least one physical network adapter 110, in accordance with a priority assigned to the quality-of-service requirements, as indicated in step 250.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. A method for transmitting time-critical data within a communication network, the method comprising:
transmitting the time-critical data at least one of (i) from control applications and (ii) to control applications which are each provided via at least one flow control component which is loadable into a flow control environment installed on a host and executable therein, a virtual network adapter being assigned to each of the flow control components;
assigning dynamically, by a queue control unit, dynamic transmit/receive queues of at least one physical network adapter of the host to the virtual network adapters;
sending, by each flow control component, a reservation order to a reservation module assigned to the flow control environment to reserve resources for at least one of sending and receiving time-critical data streams comprising time-critical data;
sending, by the reservation module, a reservation request or reservation confirmation to each communication device forwarding the respective data stream or to a higher-level control unit of the communication network for reserving the resources based on the quality-of-service requirements assigned to the flow control components; and
granting, by the queue control unit via the reservation module, access by a respective virtual network adapter of a respective flow control component to the dynamic transmit/receive queues of the least one physical network adapter, in accordance with a priority assigned to the quality-of-service requirements.

18. The method as claimed in claim 17, wherein the flow control components operate within the flow control environment isolated from one another and collectively utilize an operating system kernel of the host;
wherein the virtual network adapters are each assigned by the queue control unit to the flow control components within the flow control environment; and
wherein the resources for transmitting the data streams are reserved, given sufficient availability, in respective forwarding communication devices.

19. The method as claimed in claim 18, wherein the flow control components are one of software containers, WebAssembly and Java bytecode; and wherein the flow control environment is one of a container runtime environment, a WebAssembly runtime environment and a Java virtual machine.

20. The method as claimed in claim 17, wherein the quality-of-service requirements are each assigned to the flow control components based on a classification of their respective real-time requirements; and wherein the classification of the runtime control components occurs based on a classification guideline.

21. The method as claimed in claim 18, wherein the quality-of-service requirements are each assigned to the flow control components based on a classification of their respective real-time requirements; and wherein the classification of the runtime control components occurs based on a classification guideline.

22. The method as claimed in claim 19, wherein the quality-of-service requirements are each assigned to the flow control components based on a classification of their respective real-time requirements; and wherein the classification of the runtime control components occurs based on a classification guideline.

23. The method as claimed in claim 17, wherein the reservation module sends each reservation request or confirmation, in accordance with a reservation protocol selected for the respective flow control component, to the forwarding communication devices or the higher-level control unit of the communication network.

24. The method as claimed in claim 23, wherein the reservation module selects the reservation protocol based (i) on at least one of information provided by a forwarding communication device to which the host is connected and (ii) information provided by the higher-level control unit of the communication network.

25. The method as claimed in claim 23, wherein the reservation protocol is in accordance with, Institute of Electrical and Electronics Engineers (IEEE) standard 802.1Q.

26. The method as claimed in claim 17, wherein the queue control unit activates at least one of (i) host-internal hardware and (ii) software interfaces between the respective virtual network adapter and at least one selected transmit/receive queue upon granting the access to the transmit/receive queues of the physical network adapter; and wherein the queue control unit reserves available transmit/receive queues and at least one of hardware and software interfaces for the flow control components for transmitting the data streams upon granting the access to the transmit/receive queues.

27. The method as claimed in claim 26, wherein the queue control unit configures the physical network adapter such that reserved transmit/receive queues are available to the assigned virtual network adapters of the flow control components with the priority assigned to each respective flow control component.

28. The method as claimed in claim 27, wherein the queue control unit notifies the reservation module, following a successful configuration of the physical network adapter, of each of the network adapters and the transmit/receive queues to be used for the transmission of the data streams;
wherein the reservation module sends this information as confirmation of the reservation order to the respective flow control component;
wherein each flow control component sets up a data stream access point as a socket based on the information included by the confirmation of its respective reservation order; and
wherein the flow control components at least one of send and receive the data streams in a targeted manner via the virtual network adapters and transmit/receive queues which are to be utilized.

29. The method as claimed in claim 17, wherein the virtual network adapters are assigned as needed by the queue control unit to the flow control components for at least one of transmitting and receiving the data streams and are each connected to a functional unit to implement a network protocol stack of the respective flow control components.

30. The method as claimed in claim 17, wherein the reservation module causes the queue control unit to grant the virtual network adapter of the respective flow control component access to the transmit/receive queues of the physical network adapter only subsequent to a successful reservation.

31. The method as claimed in claim 17, wherein at least one of communication devices and control applications sending data streams, each send, for notification of subscribable data streams, first datagrams comprising a data stream identifier and specify in the first datagrams quality-of-service parameters characterizing quality-of-service requirements for the respective data stream;
wherein communication devices and/or control applications receiving data streams each send second datagrams and therein specify the respective data stream identifier for reserving resources to be provided by forwarding communication devices for transmitting the data streams; and wherein the forwarding communication devices each reserve resources, given sufficient availability, on the first and second datagrams for transmitting the data streams according to the specified quality-of-service parameters; and
wherein the availability is checked by the higher-level control unit of the communication network and/or the forwarding communication devices.

32. The method as claimed in claim 17, wherein the resources for transmitting the data streams comprise at least one of usable transfer time windows, bandwidth, assured maximum latency, queue count, queue cache and address cache in switches or bridges.

33. The method as claimed in claim 32, wherein forwarding of the data streams within the communication network is controlled via at least one of (i) frame preemption, (ii) time-aware shapers, (iii) credit-based shapers, (iv) burst limiting shapers, (v) peristaltic shapers and (vi) priority-based shapers.

34. The method as claimed in claim 33, wherein the frame preemption is in accordance with Institute of Electrical and Electronics Engineers standard 802.1Q, the time-aware shapers is in accordance with IEEE 802.1Q and the credit-based shapers is in accordance with IEEE 802.1Q.

35. A system comprising:
a flow control environment installed on a host;
at least one flow control component for providing a control application, the at least one flow control component being loadable into the flow control environment and executable therein;
a queue control unit; and
a reservation module assigned to the flow control environment;
wherein the system is configured such that time-critical data is transmitted at least one of from and to the control application and such that at least one virtual network adapter is assigned to the flow control component;
wherein the queue control unit is configured to assign transmit/receive queues of at least one physical network adapter of the host dynamically to virtual network adapters;
wherein the at least one flow control component is configured to send a reservation order to the reservation module to reserve resources for at least one of sending and receiving data streams comprising time-critical data;
wherein the reservation module is configured to send a reservation request or reservation confirmation to one of (i) the communication devices forwarding the respective data stream and (ii) a higher-level control unit of a communication network for reserving the resources based on the quality-of-service requirements assigned to each of the flow control components; and
wherein the reservation module is further configured to cause the queue control unit to grant the virtual network adapter of the respective flow control component access to the transmit/receive queues of the physical network adapter, in accordance with a priority assigned to the quality-of-service requirements.

36. The system as claimed in claim 35, further comprising:
a communication network having a plurality of communication devices;
wherein the flow control components are configured to operate within the flow control environment isolated from one another and collectively to utilize an operating system kernel of the host;
wherein the queue control unit is configured to assign a respective virtual network adapter to each respective flow control components within the flow control environment; and
wherein the communication network is configured to reserve the resources for transmitting the data streams, given sufficient availability, in respective forwarding communication devices.
